(19) United States
(12) Patent Application Publication
(10) Pub. No.: US 2020/0367512 A1
(43) Pub. Date: Nov. 26, 2020

(54) Adjustable Smoothing Device for Food Products

(71) Applicant: Igor Khashchuk, Rio Linda, CA (US)

(72) Inventor: Igor Khashchuk, Rio Linda, CA (US)

(21) Appl. No.: 16/417,383

(22) Filed: May 20, 2019

(51) Int. Cl. A21C 15/00; A21D 13/80; A21D 13/24

(52) U.S. Cl. CPC A21C 15/002; A21D 13/24; A21D 13/80

(57) ABSTRACT

An adjustable smoothing device is provided for smoothing and decorating a food item. The smoothing device includes a base plate, a supporting plate, a leveling unit, a block unit and a mounting plate. The supporting plate includes an elongated member. The leveling unit includes a ridge portion, a vertical member, a height adjustable leveling member and a level tightening means. The block unit is coupled to the elongated member and includes a groove portion. The block unit is connected to the leveling unit to form a smoothing assembly. The smoothing assembly and the elongated member are adaptable to rotate around the mounting plate along an axis of the base plate thereby enabling the vertical member and the height adjustable leveling member to smooth the food item positioned at the mounting plate.

### TECHNICAL FIELD OF THE DISCLOSURE

The present disclosure relates generally to adjustable smoothing devices and more particularly to a smoothing device for food items such as cakes and a pastries, the smoothing device having a height adjustable and rotatable smoothing assembly to produce an icing cake with smooth surface.

### DESCRIPTION OF THE RELATED ART

A wide variety of smoothing devices are available for preparing and decorating cakes and other food items. Both professional and non-professional cake makers constantly keep perfection in mind in the art of cake making as this dessert has become an inevitable part of any celebration. The cake makers apply a layer of icing on the cakes to both add to the taste and appearance of the cake. Smoothing the icing or frosting is typically done by hand, and creating a uniform and smooth layer can be challenging and time consuming. Uneven coatings of icing with lumpy surfaces can detract from the overall appearance and indeed value of a finished cake.

Several methods have been developed for creating smooth surfaced cakes. One such method describes a means for trimming, icing, leveling and smoothing of cakes or the like and includes a generally rectangular framework having posts at the four corners which adjustably receive frame rods and support instrumentalities. This cake smoothing means has a complex structure with several posts and rods, which may come into contact with the cake surface and scrape away excess frosting and smooth the frosting that remains.

Another method describes a cake decorating assembly, kit, and method of use comprising a mount which includes a longitudinally extending member. The assembly further comprises a top blade subassembly, a lateral blade subassembly, a gauge subassembly, and a cutting subassembly. This method requires separate assemblies for even distribution of frosting over top side and lateral side of a cake.

Yet another method describes a cake icing implement having a top smoother connected to a side smoother and configured to move with respect to the side smoother. The cake is rotated about its center to effect simultaneous smoothing the icing on the top surface and the side surface by the cake making implement. Since the base in this method is made of a single layer of platform, the cake may skid from the base when it is rotated.

Therefore, there is a need for a height adjustable smoothing device for making a perfect icing cake or pastry with an evenly coated surface. Such a device would be portable and designed to accommodate a variety of different sized cakes or other food items. Further, such a device would provide a rotating means to provide a uniform coating of icing on the top and lateral portions of the cake. Moreover, such a needed device would have simple structure thereby enabling easy cleaning and facilitating ease of use. Such a device would be designed to smooth the top portion and the lateral portion of the cake simultaneously. The present embodiment overcomes shortcomings in the field by accomplishing these critical objectives.

### SUMMARY OF THE DISCLOSURE

To minimize the limitations found in the prior art, and to minimize other limitations that will be apparent upon the reading of this specification, the present invention is an adjustable smoothing device used for preparing and decorating a cake or pastry.

The present invention relates to an adjustable smoothing device comprising a base plate having a raised portion with a plurality of first small rotating wheels. A supporting plate is provided with a central hole, a plurality of second small rotating wheels and an elongated member. In the preferred embodiment, the supporting plate has a star shaped design although other suitable designs are contemplated. The supporting plate is connected to the base plate by inserting the central hole through the raised portion of the base plate. A block unit coupled to the elongated member includes a groove portion and a plurality of block tightening means. The adjustable smoothing device further includes a leveling unit having a ridge portion, a height adjustable leveling member, a level tightening means and a vertical member. The height adjustable leveling member is designed to move slidably through a slot area at the leveling unit. The ridge portion of the leveling unit is designed to insert through the groove portion to form a smoothing assembly. The adjustable smoothing device includes a mounting plate positioned over the supporting plate. The mounting plate includes a plane surface to securely position the food item. Preferably, the food item may be a cake or a pastry. The smoothing assembly and the elongated member are adaptable to rotate around the mounting plate along an axis of the base plate thereby enabling the vertical member and the height adjustable leveling member to smooth the food item positioned at the mounting plate.

A first objective of the present invention is to provide an adjustable smoothing device for smoothing simultaneously both the top portion and the side portion of an icing cake.

A second objective of the present invention is to provide an adjustable smoothing device having a smoothing assembly adaptable to smooth a food item positioned at a mounting plate.

A third objective of the present invention is to provide an adjustable smoothing device with a plurality of small rotating wheels provided at the center portion of a base plate and a supporting plate to facilitate rotation of a smoothing assembly.

A fourth objective of the present invention is to provide an adjustable smoothing device having a level tightening means designed to adjust the height of a leveling member according to the dimensions of the food item.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a side perspective view of an adjustable smoothing device in accordance with the preferred embodiment of the present invention;

FIG. 2 illustrates a side perspective view of the adjustable smoothing device wherein the leveling member and the leveling unit is adjusted for making a medium food item in accordance with the preferred embodiment of the present invention;

FIG. 3 illustrates a side perspective view of the adjustable smoothing device wherein the leveling member being slid to a top portion of the slot area for smoothing a large size food item by adjusting the leveling unit of the preferred embodiment of the present invention;

FIG. 4 illustrates a side perspective view of the adjustable smoothing device wherein the leveling member being slid to a bottom portion of the slot area and the leveling unit being adjusted for smoothing a small dimensional food item in accordance with the preferred embodiment of the present invention;

FIG. 5 illustrates an exploded view of the adjustable smoothing device in accordance with the preferred embodiment of the present invention; and

FIG. 6 illustrates a flow chart of a method for adjustable smoothing device for smoothing the surface of a food item in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means+/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

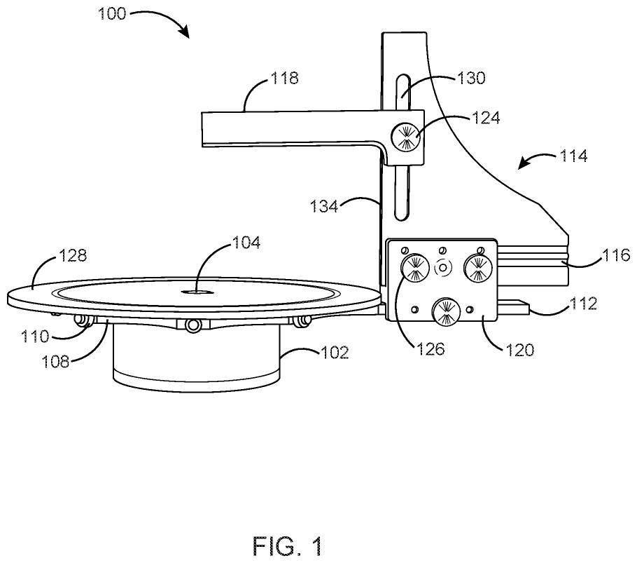

FIG. 1 illustrates a side perspective view of an adjustable smoothing device 100 for a food item. The adjustable smoothing device 100 includes a base plate 102 having a raised portion 104 with a plurality of first small rotating wheels 106. A supporting plate 108 is provided with a central hole, a plurality of second small rotating wheels 110 and an elongated member 112. In the preferred embodiment, the supporting plate 108 has a star shaped design. The supporting plate 108 is connected to the base plate 102 by inserting the central hole through the raised portion 104 of the base plate 102. A block unit 120 coupled to the elongated member 112 includes a groove portion 122 and a plurality of block tightening means 126. The adjustable smoothing device 100 further includes a leveling unit 114 having a ridge portion 116, a height adjustable leveling member 118, a level tightening means 124 and a vertical member 134. The height adjustable leveling member 118 is designed to move slidably through a slot area 130 at the leveling unit 114. The ridge portion 116 of the leveling unit 114 is designed to insert through the groove portion 122 to form a smoothing assembly. The adjustable smoothing device 100 includes a mounting plate 128 positioned over the supporting plate 108. The mounting plate 128 includes a plane surface to securely position the food item. Preferably, the food item may be a cake or a pastry. The smoothing assembly and the elongated member 112 are adaptable to rotate around the mounting plate 128 along an axis of the base plate 102 thereby enabling the vertical member 134 and the height adjustable leveling member 118 to smooth the food item positioned at the mounting plate 128.

A mounting plate 128 having a plane surface is positioned over the supporting plate 108. The smoothing assembly is adaptable to rotate around the mounting plate 128 along an axis of the base plate 102 thereby enabling the vertical member 134 and the height adjustable leveling member 118 to smooth the food item positioned at the mounting plate 128. The food item is preferably a cake or a pastry, however any item with frosting, icing, butter, or other smoothable food agent is suitable. The ridge portion 116 includes a plurality of ridges 132 that enables the height adjusting leveling member 118 to firmly connect to the block unit 120. The level tightening means 124 is designed to adjust the height of the leveling member 118 according to the dimensions of the food item such as a cake.

The plurality of first small rotating wheels 106 and the plurality of second small rotating wheels 110 enable the smoothing assembly to rotate around the mounting plate 128. Preferably, the vertical member 134 and the leveling member 118 are designed for smoothing a side portion and a top portion of the food item respectively. The plurality of first small rotating wheels 106 and the second small rotating wheels 110 facilitates the rotational movement of the elongated member 112 and the smoothing assembly. As the smoothing assembly rotates, the leveling member 118 and the vertical member 134 remove the excess icing or cream on the top surface and at the sides of the food item thereby providing a smooth surface to the food item. The plurality of block tightening means 126 adjusts the connection between the block unit 120 and the leveling unit 114. If the cake is to be smoothen in large size, then the smoothing assembly is repositioned away from the center of the mounting plate 128. This is achieved by adjusting the plurality of block tightening means 126 so that the cake can be perfectly positioned on the mounting plate 128.

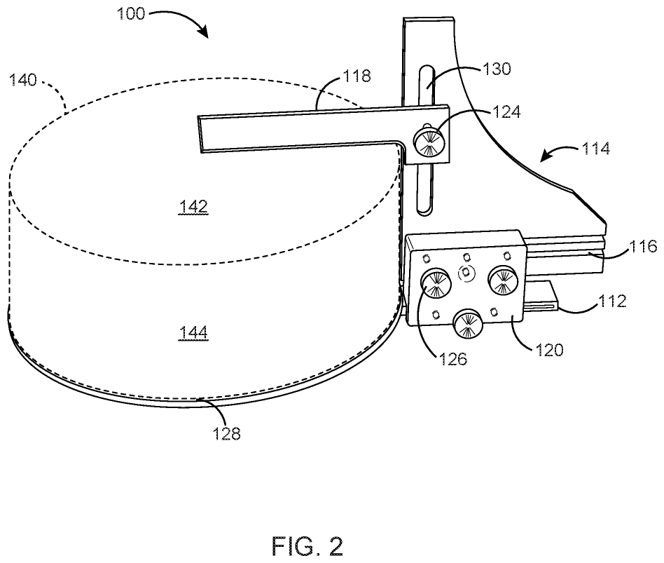

FIG. 2 illustrates a side perspective view of the adjustable smoothing device 100. The adjustable smoothing device 100 is used for smoothing the icing of a food item, a cake for example, on top potion as well as the side portion simultaneously. Cakes are commonly made 6, 9 and 12 inches in diameter, though this adjustable smoothing device 100 provides with mounting plate 128 for holding the cake in a fixed position while the frosting is smoothed on a cake of any size the fits within the dimensions of the device. The height adjustable leveling member 118 moves slidably towards top to bottom through the slot area 130 at the leveling unit 114 to adjust with the height of the food item. The leveling unit 114 having the ridge portion 116 that are positioned on the block unit 120 coupled to the elongated member 112 includes the groove portion 122. The ridge portion 116 of the leveling unit 114 inserted through the groove portion 122 is tightened using the plurality of block tightening means 126.

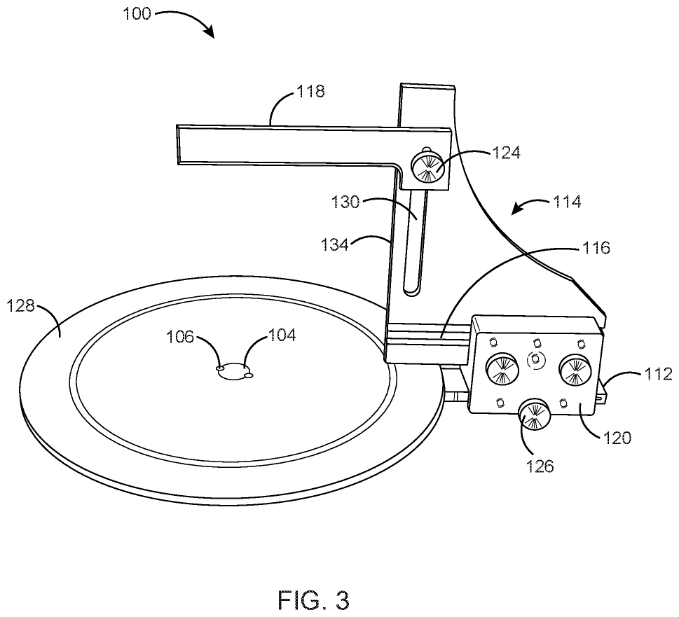

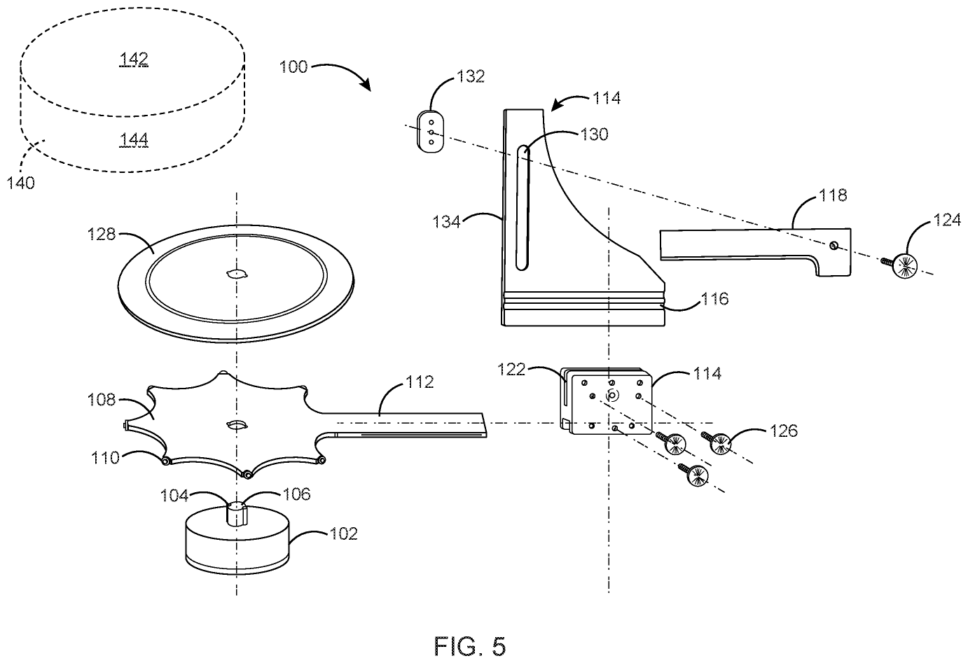

FIG. 3 illustrates a side perspective view of the adjustable smoothing device 100. The plurality of second small rotating wheels 110 is positioned at the end portions of the star shaped supporting plate 108 that enables a smooth rotation of elongated member 112 around the mounting plate 128 where the food item is kept for smoothing. The adjustable smoothing device 100 reduces the time consumption. A person without any cake making skills can easily use the adjustable smoothing device 100 without any trouble. The plurality of block tightening means 126 adjusts the connection between the block unit 120 and the leveling unit 114. The height adjustable leveling member 118 is used for adjusting the height for smoothing the top portion of the food item. According to the height of the food item, the height adjusting leveling member 118 is slid through the slot area 130 toward top and bottom. When the adjustable leveling member 118 reaches the height of the food item, the height adjustable leveling member 118 is tightened with the level tightening means 124 having a tightening locker 136 (FIG. 5).

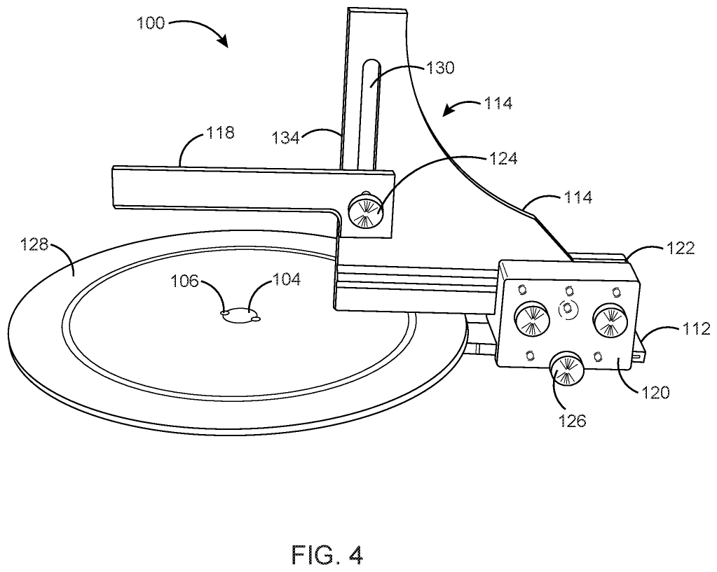

FIG. 4 illustrates a side perspective view of the adjustable smoothing device 100. The preferred embodiment provides direct contact between the cake and the vertical member 134 of the leveling unit 114 for perfect smoothing. In one embodiment, the adjustable smoothing device 100 provides a plurality of smoothing tools designed to create a zig zag mold or a wave shape in cake as the smoothing assembly and the elongated member rotate around the mounting plate 128 of the food item.

FIG. 5 illustrates an exploded view of an adjustable smoothing device 100. The adjustable smoothing device 100 includes the base plate 102 with the raised portion 104 including the plurality of first small rotating wheels 106. The supporting plate 108 with a star shaped design is provided with the plurality of second small rotating wheels 110 at the end of the supporting plate 108. The plurality of second small rotating wheels 110 provides a smooth rotation for the elongated member 112 to rotate around the mounting plate 128 for smooth assembly. The supporting plate is connected to the base plate 102 by inserting the central hole through the raised portion 104 of the base plate 102. The block unit 120 having the plurality of block tightening means 126 to tighten the leveling unit 114 through the grooves 122 for the smoothing assembly. The block unit 120 being coupled to the elongated member 112 includes the groove portion 122.

The leveling unit 114 has the ridge portion 116 and the height adjustable leveling member 118 including the slot portion 130 with the level tightening means 124 and its tightening locker 136. The tightening means is to tighten the leveling member 118. The level tightening means 124, for tightening the height adjustable leveling member 118 for adjusting the height of the food item, that provides the plurality of block tightening means 126 is tightened through inside the groove portion 122 for tightening the leveling unit 114 firmly for smoothing the food item. The mounting plate 128 having a plane surface is positioned over the supporting plate 108. The smoothing assembly is adaptable to rotate around the mounting plate 128 along an axis of the base plate 102 thereby enabling the vertical member 134 and the height adjustable leveling member 118 to smooth the food item positioned at the mounting plate 128.

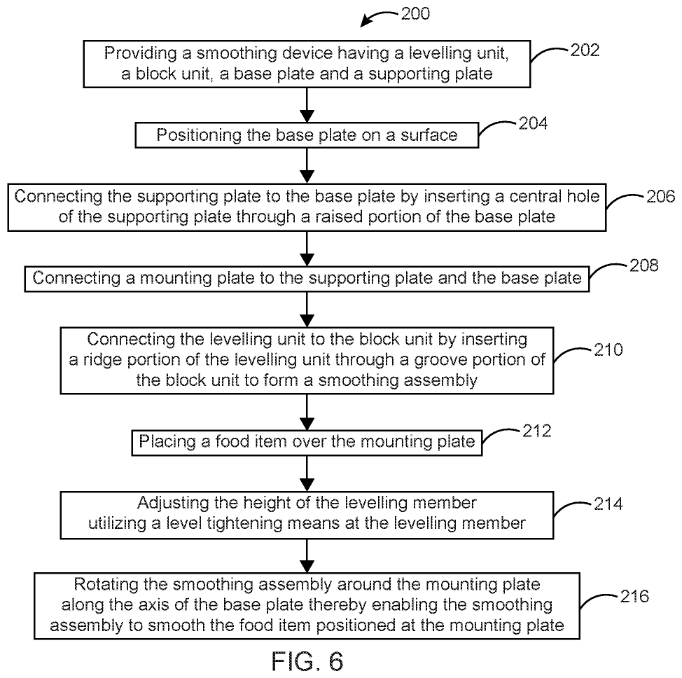

FIG. 6 illustrates a flow chart of a method for smoothing the surface of a food item utilizing the adjustable smoothing device 200. The method commences by providing a smoothing device having a leveling unit, a block unit, a base plate and a supporting plate as indicated at block 202. Then, the base plate is positioned on a surface as indicated at block 204. Next, the supporting plate is connected to the base plate by inserting the central hole of the supporting plate through the raised portion of the base plate as indicated at block 206. Thereafter, the mounting plate is connected to the supporting plate and the base plate as indicated in block 208. Next, the leveling unit is connected to the block unit by inserting the ridge portion of the leveling unit through the groove portion of the block unit to form the smoothing assembly as indicated at block 210. Then, the food item is placed over the mounting plate as indicated at block 212. Next, for the height of the leveling member is adjusted utilizing the level tightening means at the leveling member as indicated in block 214. Finally, the smoothing assembly is rotated at the mounting plate along the axis of the base plate thereby enabling the smoothing assembly to smooth the food item positioned at the mounting plate as indicated at block 216.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

1. An adjustable smoothing device for a food item comprising:
a base plate having a plurality of first small rotating wheels;
a supporting plate connected to the base plate includes an elongated member and a plurality second small rotating wheels;
a leveling unit having a ridge portion, a vertical member, a height adjustable leveling member and a level tightening means;
a block unit coupled to the elongated member includes a groove portion, the block unit being connected to the leveling unit to form a smoothing assembly; and
a mounting plate connected to the supporting plate, the smoothing assembly and the elongated member being adaptable to rotate around the mounting plate along an axis of the base plate thereby enabling the vertical member and the height adjustable leveling member to smooth the food item positioned at the mounting plate;
whereby the rotational movement of the smoothing assembly and the shaft provides a smooth and uniform surface to the food item.

2. The adjustable smoothing device of claim 1 wherein the supporting plate is connected to the base plate by inserting a central hole of the supporting plate through a raised portion of the base plate.

3. The adjustable smoothing device of claim 1 wherein the ridge portion of the leveling unit is inserted through the groove portion of the block unit to form the smoothing assembly.

4. The adjustable smoothing device of claim 1 wherein the ridge portion includes a plurality of ridges that enables the leveling member to firmly connect to the block unit.

5. The adjustable smoothing device of claim 1 wherein the plurality of first small rotating wheels is positioned at the raised portion.

6. The adjustable smoothing device of claim 1 wherein the plurality of first small rotating wheels and the plurality of second small rotating wheels enable the smoothing assembly to rotate around the mounting plate.

7. The adjustable smoothing device of claim 1 wherein the vertical member and the leveling member are utilized for smoothing a side portion and a top portion of the food item respectively.

8. The adjustable smoothing device of claim 1 wherein the level tightening means is designed to adjust the height of the leveling member according to the dimensions of the food item.

9. The adjustable smoothing device of claim 1 wherein the block unit includes a plurality of block tightening means for adjusting the connection between the block unit and the leveling unit.

10. The adjustable smoothing device of claim 1 wherein the height adjustable leveling member is designed to move slidably through a slot area at the leveling unit to adjust the height according to the dimensions of the food item.

11. An adjustable smoothing device for a food item comprising:
a base plate having a raised portion with a plurality of first small rotating wheels;
a supporting plate having a central hole, a plurality of second small rotating wheels and an elongated member, the supporting plate being connected to the base plate by inserting the central hole through the raised portion;
a leveling unit having a ridge portion, a vertical member, a level tightening means and a height adjustable leveling member designed to move slidably through a slot area at the leveling unit;
a block unit coupled with the elongated member includes a groove portion and a plurality of block tightening means, the ridge portion of the leveling unit being designed to insert through the groove portion to form a smoothing assembly; and
a mounting plate positioned over the supporting plate, the smoothing assembly and the elongated member being adaptable to rotate around the mounting plate along an axis of the base plate thereby enabling the vertical member and the height adjustable leveling member to smooth the food item positioned at the mounting plate;
whereby the rotational movement of the smoothing assembly and the elongated member provides a smooth and uniform surface to the food item.

12. The adjustable smoothing device of claim 11 wherein the ridge portion includes a plurality of ridges that enables the leveling member to firmly connect to the block unit.

13. The adjustable smoothing device of claim 11 wherein the level tightening means is designed to adjust the height of the leveling member according to the dimensions of the food item.

14. The adjustable smoothing device of claim 11 wherein the plurality of first small rotating wheels and the plurality of second small rotating wheels enable the smoothing assembly to rotate around the mounting plate.

15. The adjustable smoothing device of claim 11 wherein the vertical member and the leveling member are utilized for smoothing a side portion and a top portion of the food item respectively.

16. The adjustable smoothing device of claim 11 wherein the plurality of block tightening means for adjusting the connection between the block unit and the leveling unit.

17. A method for smoothing a food item utilizing an adjustable smoothing device, the method comprising the steps of:
a) providing the smoothing device having a leveling unit, a block unit, a base plate and a supporting plate;
b) positioning the base plate on a surface;
c) connecting the supporting plate to the base plate by inserting a central hole of the supporting plate through a raised portion of the base plate;
d) connecting a mounting plate to the supporting plate and the base plate;
e) connecting the leveling unit to the block unit by inserting a ridge portion of the leveling unit through a groove portion of the block unit to form a smoothing assembly;
f) placing a food item over the mounting plate;
g) adjusting the height of a leveling member of the leveling unit utilizing a level tightening means at the leveling member; and
h) rotating the smoothing assembly around the mounting plate along the axis of the base plate thereby enabling the smoothing assembly to smooth the food item positioned at the mounting plate.
whereby the rotational movement of the smoothing assembly provides a smooth and uniform surface to the food item.

18. The method of claim 17 wherein the base plate includes a plurality of first small rotating wheels and the supporting plate includes a plurality of second small rotating wheels.

19. The method of claim 17 wherein the plurality of first small rotating wheels and the plurality of second small rotating wheels enable the smoothing assembly to rotate around the mounting plate.

20. The method claim of claim 17 wherein the leveling member and a vertical member at the leveling unit are utilized for smoothing a top portion and a side portion of the food item respectively.
